(19) United States
(12) Patent Application Publication
(10) Pub. No.: US 2024/0178711 A1
(43) Pub. Date: May 30, 2024

(54) STRUCTURE FOR AN ELECTRIC MACHINE OF AN AIRCRAFT

(71) Applicant: Rolls-Royce Deutschland Ltd & Co KG, Blankenfelde-Mahlow (DE)

(72) Inventor: Daniel MERZ, München (DE)

(21) Appl. No.: 18/522,201

(22) Filed: Nov. 28, 2023

(30) Foreign Application Priority Data
Nov. 29, 2022 (DE) 10 2022 131 620.3

(51) Int. Cl. H02K 1/20; H02K 5/20; H02K 7/14

(52) U.S. Cl. CPC H02K 1/20; H02K 5/20; H02K 7/14

(57) ABSTRACT

A structure for an electric machine includes a stator, a housing, and a cooling system for cooling the stator. The cooling system is configured to remove heat from the stator at a predefined reference temperature with a heat-removal rate that is greater than or equal to 5 kW.

This application claims the benefit of German Patent Application No. 10 2022 131 620.3, filed on Nov. 29, 2022, which is hereby incorporated by reference in its entirety.

### BACKGROUND

The present disclosure relates to a structure for an electric machine, to an electric machine, and to an aircraft engine.

Aircrafts are powered in many different ways. Internal combustion engines (e.g., piston engines or gas turbine engines) enable long ranges and high speeds. Propulsion systems with one or more electric motors enable the use of sustainably generated energy and are often particularly quiet and only require little maintenance.

In the aerospace sector, for example, large drive powers are often required, while at the same time the smallest possible engines are desired. Also, a low total weight is typically aimed for. A particular challenge in the aviation sector is also posed by the ambient conditions, which may exhibit varying temperatures over a very wide range. While electric propulsion engines of aircrafts are heated during operation, where temperatures of 70° ° C. may be reached, for example, an aircraft with such a propulsion engine may be cooled down to −40° C. or even lower (e.g., during parking on a cold airfield). This usually imposes a limit on the performance of the propulsion engine, as individual components expand to different extents at the various temperatures.

### SUMMARY

The scope of the present invention is defined solely by the appended claims and is not affected to any degree by the statements within this summary.

The present embodiments may obviate one or more of the drawbacks or limitations in the related art. For example, resistance against plastic deformation or break of an electric machine at low ambient temperatures may be improved.

According to an aspect, a structure for an electric machine includes a stator, a housing, and a cooling system for cooling the stator. The cooling system is configured to remove heat from the stator at a predefined reference temperature with a heat-removal rate that is greater than or equal to 5 kW.

The heat-removal rate may be equal to 10 kW. The heat-removal rate may be smaller than or equal to 12 kW. The heat-removal rate may be in a range between 5 kW and 12 kW.

The predefined reference temperature may be 50° C.

The cooling system may include one or more cooling segments arranged between the housing and the stator.

The cooling system may include more than 40 cooling segments. For example, the cooling system includes 48 cooling segments.

The cooling system may include cooling channels for a cooling fluid.

Each of the cooling channels may have a surface area of 9000 mm²+/−10% (e.g., of 9024 mm²).

The cooling channels of the cooling system may have a total surface area of at least 1 m², at least 2 m², or at least 3 m² (e.g., of 3.5 m²+/−10%).

The cooling fluid may be air (e.g., environmental air).

The cooling system may be configured to supply the cooling fluid to the cooling channels with a mass-flow rate in a range between 0.3 kg/s and 1.5 kg/s (e.g., with a mass-flow rate of 0.7 kg/s).

The cooling channels may extend in parallel to one another and may be arranged at different locations around the stator.

Each of the cooling segments may include one or more cooling channels (e.g., 2 or more, 3 or more, 4 or more, 5 or more, 6 or more, or 7 or more cooling channels).

The cooling system may be configured to transmit torque between the stator and the housing.

The housing may be coaxially arranged with the stator.

The stator may be arranged within the housing.

The stator may include electric coils, and a rotor with permanent magnets may be mounted rotatable with respect to the stator.

An electric machine may include the structure described herein.

An aircraft engine may include the structure described herein and a rotor unit with rotor blades.

According to an aspect, a structure for an electric machine includes a stator, a housing, and a cooling system for cooling the stator. The stator is operable with a maximum electric power, and the cooling system is configured to remove heat from the stator at a predefined reference temperature with a heat-removal rate. The ratio of the heat-removal rate divided by the maximum electric power is greater than or equal to 0.015 (e.g., corresponding to 1.5%).

The maximum electric power may be more than 100 KW, more than 200 kW, or more than 300 kW. For example, the maximum electric power is 320 kW.

According to one aspect, a structure for an electric machine is described. The system includes a stator (e.g., an inner stator) in the form of a retaining ring extending around an axis with holders for magnetically (e.g., electromagnetically) active elements, a housing in the form of a housing ring (e.g., an outer housing ring) arranged coaxially with the stator, and a plurality of cooling segments arranged to form a ring. Each cooling segment of the plurality of cooling segments at least partially forms at least one cooling channel for a cooling fluid. The cooling fluid may be gaseous and/or liquid. Thereby, the ring of cooling segments is arranged between the stator and the housing. Further, the stator and the ring of the cooling segments are fixed relative to one another in a form-fitting and/or friction-fitting manner, and the ring of the cooling segments and the housing are fixed relative to one another in a form-fitting and/or friction-fitting manner (e.g., in each case with respect to a rotation about the common axis).

By segmenting the ring of cooling segments located between the housing and the stator, significantly lower stresses are created in the circumferential direction as a result of temperature fluctuations, even if the cooling segments are made of a material that is configured for good cooling performance and therefore may have a different coefficient of thermal expansion than the stator and/or the housing. At the same time, the fixed connections between the stator and the cooling segments and between the cooling segments and the housing provide torque transmission. Thus, it is possible to improve both the resistance (e.g., to plastic deformation or fracture) and the performance of an electric machine including the structure at low ambient temperatures. One or more positive connections may be provided for redundancy in addition to a frictional connection.

Optionally, at least one of the cooling segments includes a form-fitting element that cooperates (e.g., engages) with a form-fitting element of the retaining ring in such a way that a torque about the axis may be transmitted between the stator and the ring of the cooling segments. Alternatively or additionally, it is optionally provided that at least one of the cooling segments has a form-fitting element that cooperates (e.g., engages) with a form-fitting element of the housing, such that a torque may be transmitted about the axis between the ring of the cooling segments and the housing.

The stator, the housing, and the cooling segments each have a coefficient of thermal expansion. It may be provided that the coefficient of thermal expansion of the stator and the coefficient of thermal expansion of the housing are closer to each other than, respectively, to the coefficient of thermal expansion of the cooling segments. The coefficients of thermal expansion of the stator and the housing may be matched to each other. This provides that the cooling segments are held securely over a wide temperature range.

For example, the stator and the housing have similar or equal coefficients of thermal expansion (e.g., in one embodiment, similar but not equal). Optionally, the coefficient of thermal expansion of the stator is equal to, for example, the coefficient of thermal expansion of the housing +/−30%, +/−20%, +/−10%, or +/−5% (e.g., of the coefficient of thermal expansion of the housing). As a result, the cooling segments are sandwiched between two components that expand or shrink in approximately the same manner, whereby the retention of the cooling segments over a wide temperature range may be particularly improved. The ratio of the coefficient of thermal expansion of the stator divided by the coefficient of thermal expansion of the housing may be in a range between 0.7 and 1.3, in a range between 0.8 and 1.2, in a range between 0.9 and 1.1, or in a range between 0.95 and 1.05. It may be provided that the ratio is in one of these ranges but is not equal to 1 (or, for example, is not in the range of between 0.99 and 1.01).

Optionally, the coefficient of thermal expansion of the stator is between 8.8e-6 1/K and 10.9e-6 1/K. For example, the stator is made of electrical sheet. This enables good magnetic properties.

For example, the coefficient of thermal expansion of the housing is between 8.6e-6 1/K and 12e-6 1/K. For example, the housing is made of Ti-6Al-4V or steel or other titanium alloy. Ti-6Al-4V is a high strength titanium alloy and includes (or consists of) titanium, (e.g., about or exactly) 6 mass percent aluminum, and (e.g., about or exactly) 4 mass percent vanadium.

An interference fit may be formed between the stator, the ring of the cooling segments, and the housing. This enables good heat transfer from the stator to the cooling segments and may also improve the transmission of torque.

The cooling segments may be made of aluminum and/or magnesium or include aluminum and/or magnesium. These materials enable particularly good heat transfer from stator to cooling medium and are also relatively light.

Compared to one another, the stator and the housing may be made of different materials. For example, the housing is made of a particularly stiff and/or light material, while the stator is made of a material with particularly good magnetic properties, for example.

The stator may be arranged inside the ring of cooling segments. The housing may be arranged outside the ring of cooling segments. This allows the housing to securely hold the cooling segments to the stator.

The housing optionally includes fastening points for fastening to a support (e.g., of an aircraft).

Magnetically active elements in the form of the coils of the stator, for example, may be mounted on the holders. The holders may be in the form of teeth. The teeth may be directed radially inwards. Such teeth allow a secure holding of the coils and a good guidance of the magnetic field lines.

The structure may further include, for example, magnetically active elements in the form of the coils wound around the holders (e.g., in the form of the teeth).

Within the stator, an opening may be formed for a rotor of the electric machine. Thus, the electric machine may be of an internal-rotor type. Alternatively, the electric machine may be of an external-rotor type, for example.

According to one aspect, an electric machine is provided (e.g., for a vehicle, such as for an aircraft). The electric machine includes the structure according to any embodiment described herein with the stator having magnetically active elements (e.g., in the form of coils) and a rotor mounted for rotation about the axis relative to the stator. With regard to the advantages, reference is made to the above.

According to one aspect, there is provided an aircraft including a rotor unit having rotor blades and the electric machine according to any embodiment described herein for driving the rotor unit. The rotor unit and the electric machine form a propulsion system for the aircraft. The propulsion system is used to generate thrust and/or lift for the aircraft.

According to one aspect, a method of manufacturing a structure for an electric machine is disclosed (e.g., for manufacturing the structure according to any embodiment described herein). The method includes providing a stator (e.g., in the form of a retaining ring) extending about an axis and having mountings for magnetically active elements, a housing (e.g., in the form of a ring), and a plurality of cooling segments each at least partially forming at least one cooling channel for a cooling fluid. The method includes mounting of the stator, the housing, and the cooling segments such that the cooling segments are arranged in a ring. The ring of cooling segments is arranged between the stator and the housing arranged coaxially with the stator. The stator and the ring of the cooling segments are fixed relative to one another in a form-fitting and/or friction-fitting manner, and the ring of the cooling segments and the housing are fixed relative to one another in a form-fitting and/or friction-fitting manner. With regard to the advantages, reference is again made to the above disclosures.

Optionally, the mounting is performed such that a form-fitting element of at least one of the cooling segments cooperates (e.g., is used in engagement) with a form-fitting element of the stator such that the ring of cooling segments is arranged between the stator and the housing arranged coaxially with the stator (e.g., is brought into engagement) with a form-fitting element of the stator such that a torque may be transmitted about the axis between the stator and the ring of cooling segments. A form-fitting element of at least one of the cooling segments interacts (e.g., is brought into engagement) with a form-fitting element of the housing such that a torque may be transmitted about the axis between the ring of cooling segments and the housing.

Optionally, for providing the stator a material for manufacturing, the stator is selected based on the coefficient of thermal expansion of the housing, or, for example, for providing the housing a material for manufacturing, the housing is selected based on the coefficient of thermal expansion of the stator. Thus, the coefficients of thermal expansion of the stator and the housing may be matched. A pair of materials having at least similar coefficients of thermal expansion may be selected for the stator and the housing.

According to one aspect, there is disclosed a structure for an electric machine including a stator extending around an axis and having mountings for magnetically active elements, a housing arranged coaxially with the stator, and a plurality of cooling segments arranged to form a ring, each cooling segment at least partially forming at least one cooling channel for a cooling fluid. In this case, the ring of cooling segments is arranged between the stator and the housing, where the coefficient of thermal expansion of the stator is equal to, for example, the coefficient of thermal expansion of the housing +/−30%, +/−20%, +/−10%, or +/−5% of the coefficient of thermal expansion of the housing. Alternatively or additionally, the coefficient of thermal expansion of the stator and the coefficient of thermal expansion of the housing are closer to each other than respectively to the coefficient of thermal expansion of the cooling segments. For example, the stator and the housing have similar or equal coefficients of thermal expansion (e.g., in one embodiment, similar but dissimilar coefficients of thermal expansion (see above)).

### BRIEF DESCRIPTION OF THE DRAWINGS

Embodiments are now described with reference to the figures, in which schematic representations are provided:

FIG. 1 shows an aircraft in the form of an airplane with an electrically driven rotor unit;

FIG. 2 shows an aircraft engine of the aircraft according to FIG. 1 with an electric machine;

FIG. 3 shows a structure of the electric machine according to FIG. 2 with a stator, a number of cooling segments, and a housing;

FIG. 4 shows an optional embodiment of a structure for the electric machine according to FIG. 2; and

FIG. 5 shows a method of manufacturing a structure for an electric machine and the electric machine.

### DETAILED DESCRIPTION

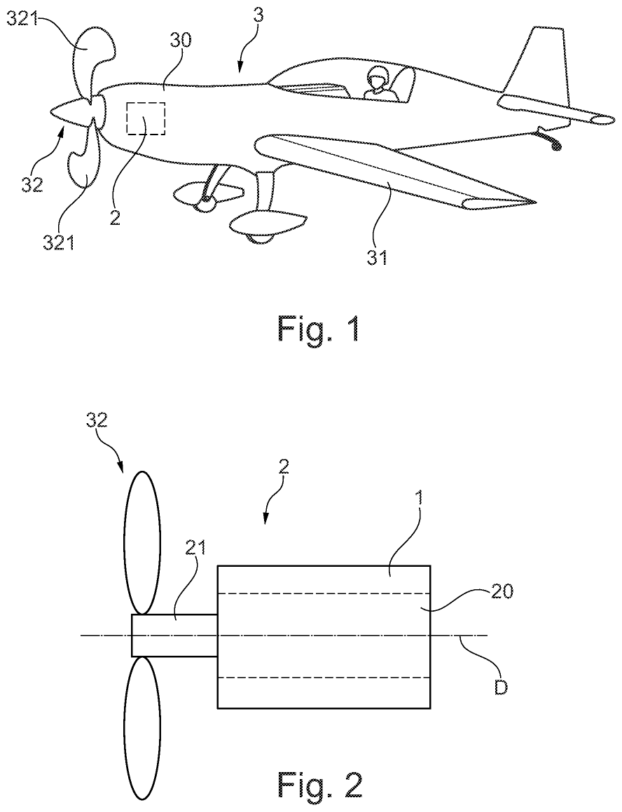

FIG. 1 shows an aircraft 3 in the form of an electrically powered airplane having a fuselage 30 and wings 31.

The aircraft 3 includes an aircraft engine as a propulsion system including a rotor unit 32 driven by an electric machine 2 of the aircraft engine. The rotor unit 32 includes a plurality of rotor blades 221 (e.g., two rotor blades 221). In the example shown, the two rotor blades 221 are mounted on a hub to form a propeller. In alternative embodiments, the aircraft 3 includes, for example, a fan instead of a propeller and/or a plurality of propulsion systems each including at least one propeller, fan, or the like.

FIG. 2 shows the aircraft engine including the electric machine 2 of the aircraft 3. The electric machine 2 is configured in the form of an electric motor (e.g., that may additionally or alternatively be used as a generator). Specifically, the electric machine 2 is configured as a radial flux machine. The electric machine 2 includes a structure 1 described in more detail below, a rotor 20, and a shaft 21.

The rotor 20 is mounted for rotation about an axis D relative to the structure 1. The structure 1 is fixedly mounted to a support of the aircraft 3. For example, the structure 1 is fixed relative to the fuselage 30.

The rotor 20 generally includes at least one base to which a plurality of magnets (e.g., surface mounted) in the form of permanent magnets are secured. The plurality of magnets are fixed to the base of the rotor 20 around an axis D with alternating polarity in pairs. Permanently excited electric machines permit particularly high power densities and torque densities. The base is fixed to the shaft 21. The plurality of magnets face coils of the structure 1.

An electric current through the coils generates a magnetic field that causes the rotor 20 to rotate about the axis D. The electric machine 2 drives the rotor unit 32 via the shaft 21. For example, the rotor unit 32 is attached to or otherwise operatively connected to the shaft 21.

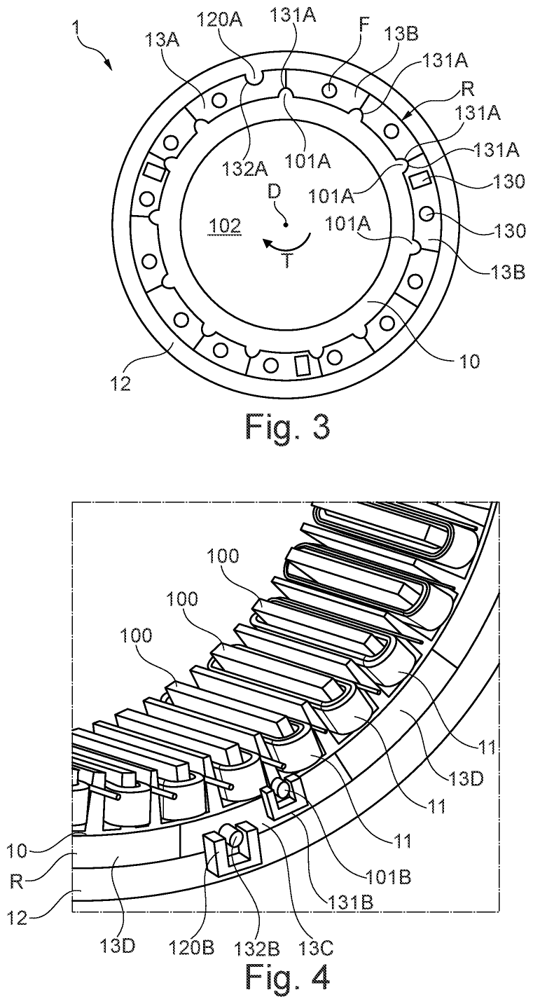

FIG. 3 shows the structure 1 of the electric machine 2. The structure 1 includes an inner ring as a stator 10 extending around the axis D with holders 100 for magnetically active elements 11 (e.g., in the form of coils; not shown in FIG. 3 but explained below with reference to FIG. 4). The stator 10 may also be referred to as a stator ring. The structure 1 further includes an outer housing 12 in the form of a ring arranged coaxially with the stator 10. Further, the structure 1 includes a plurality of cooling segments 13A, 13B. Each cooling segment 13A, 13B of the plurality of cooling segments 13A, 13B forms at least part of a cooling channel 130 for a gaseous or liquid cooling fluid F. The plurality of cooling segments 13A, 13B are arranged to form a ring R and are arranged between the stator 10 and the housing 12. In the present case, the cooling channels 130 are each in the form of a channel extending through a respective cooling segment 13A, 13B of the plurality of cooling segments 13A, 13B. The cooling fluid F is, for example, air (e.g., external air from an external environment of the aircraft 3) or, alternatively, for example, water. Thus, the cooling fluid F may flow through individual cooling segments 13A, 13B of the plurality of cooling segments 13A, 13B. The cooling channels 130 may be circular, square, rectangular, or otherwise shaped in cross-section. A number or all of the cooling channels 130 may have the same cross-sectional shape. A single (e.g., each) cooling segment 13A, 13B of the plurality of cooling segments 13A, 13B may form multiple cooling channels.

The stator 10 and the ring R of the cooling segments 13A-13D are generally positively and/or frictionally fixed to each other (e.g., positively and frictionally), so that a torque T is transmittable between the stator 10 and the ring R of the cooling segments 13A, 13B about the axis D, and the ring R of the cooling segments 13A-13D and the housing 12 are generally positively and/or frictionally fixed to one another (e.g., positively and frictionally), so that a torque T may be transmitted about the axis D between the ring R of the cooling segments 13A, 13B and the housing 12.

In the example shown, it is provided that at least one of the cooling segments 13A, 13B includes a (e.g., positive-locking) form-fitting element 131A that cooperates with a suitably formed (e.g., positive-locking) form-fitting element 101A of the stator 10 and is specifically in engagement such that a torque T may be transmitted between the ring R of the cooling segments 13A, 13B and the stator 10 about the axis D via the form-fitting elements 101A, 131A. In the present case, the stator 10 includes a plurality of form-fitting elements 101A. Specifically, each of the form-fitting elements 101A of the stator 10 is formed as a radially outwardly projecting projection. In the example shown, each of the cooling segments 13A, 13B includes two form-fitting elements 131A for a respective form-fitting element 101A of the stator 10. Each of the cooling segments 13A, 13B has two ends as viewed circumferentially about the axis D that are adjacent to a respective adjacent cooling segment 13A, 13B as viewed circumferentially. The form-fitting elements 131A of the cooling segments 13A, 13B for the stator 10 are formed at the ends of the cooling segments 13A, 13B.

The form-fitting elements 131A of the cooling segments 13A, 13B for the stator 10 are each formed in the form of a receptacle for an associated form-fitting element 101A of the stator 10. Presently, two form-fitting elements 131A of two adjacent cooling segments 13A, 13B each embrace a form-fitting element 101A of the stator 10.

In the present example, at least one of the cooling segments 13A, 13B further includes a form-fitting element 132A cooperating with a form-fitting element 120A of the housing 12, specifically in engagement, in such a way that a torque T about the axis D is transmittable between the ring R of the cooling segments 13A, 13B and the housing 12. In the example shown, precisely one of the cooling segments 13A, 13B includes such a form-fitting element 132A. Exemplarily, this form-fitting element 132A is formed in the form of a radially inwardly directed receptacle. The suitably formed form-fitting element 120A of the housing 12 protrudes radially inwardly from the housing 12. The form-fitting element 120A of the housing 12 is received in the form-fitting element 132A of the cooling segment 13A. In the present example, exactly one form-fitting element 120A is formed on the housing 12; however, alternatively, a plurality of form-fitting elements 120A on the housing 12 may cooperate with a plurality of form-fitting elements 132A of the cooling segments 13A, 13B.

The sides of the cooling segments 13A, 13B facing the stator 10 may each be polygonal in shape.

The housing 12 is formed in one piece, but may also be formed in multiple pieces. The stator 10 is also formed in one piece, but may also be formed in a number of pieces.

The stator 10 defines an opening 102 in which, when the electric machine 2 is assembled, the rotor 20 is rotatably disposed.

In the present case, the coefficients of thermal expansion (CTE) of the stator 10 and the housing 12 are matched to each other (e.g., are similar). In this regard, the coefficient of thermal expansion of the stator 10 and the coefficient of thermal expansion of the housing 12 are closer to each other than, respectively, to the coefficient of thermal expansion of the cooling segments 13A-13D. Specifically, the coefficient of thermal expansion of the stator 10 may be equal to the coefficient of thermal expansion of the housing 12; although, alternatively, there may also be a deviation of, for example, +/−30%, +/−20%, +/−10%, or +/−5% of the coefficient of thermal expansion of the housing 12. The coefficient of thermal expansion of the cooling segments 13A, 13B is greater than the coefficients of thermal expansion of the stator 10 and the housing 12 (e.g., twice as great or even greater).

For example, it is provided that the coefficient of thermal expansion of the stator 10 is between 8.8e-6 1/K and 10.9e-6 1/K, the coefficient of thermal expansion of the housing 12 is between 8.6e-6 1/K and 12e-6 1/K, and the coefficient of thermal expansion of the cooling segments 13A, 13B is each more than 23e-6 1/K. The cooling segments 13A, 13B are made of aluminum and/or magnesium.

An interference fit is formed between the stator 10, the ring R of the cooling segments 13A, 13B, and the housing 12.

The stator 10 and the housing 12 are made of different materials (e.g., electrical sheet (stator 10) and Ti-6Al-4V (housing 12)). Therefore, the thermal expansion coefficients of the stator 10 and the housing 12, respectively, are not identical but are similar.

The segmentation of the ring R of cooling segments 13A, 13B is made possible by the use of the outer housing 12. Due to the similar thermal expansion coefficients of the stator 10 and the housing 12 and the segmentation of the ring R of cooling segments 13A, 13B, thermal stresses in the circumferential direction are significantly reduced, so that the electric machine 2 is suitable for a particularly wide temperature range.

FIG. 4 shows a part of a stator 10 with holders 100 for magnetically active elements 11 in the form of coils. The holders 100 are in the form of teeth for the coils. The coils are each wound around one of the holders 100. The holders 100 are thereby arranged equidistantly to each other and around the axis D.

FIG. 4 further shows other examples of form-fitting elements, where an axially projecting pin as a form-fitting element 101B of the stator 10 engages between two portions of a form-fitting element 131B formed as a fork of one of the cooling segments 13C, 13D. Further, an axially projecting pin as a form-fitting element 132B of one (e.g., the same) of the cooling segments 13C engages between two portions of a form-fitting element 120B formed as a fork of the housing 12.

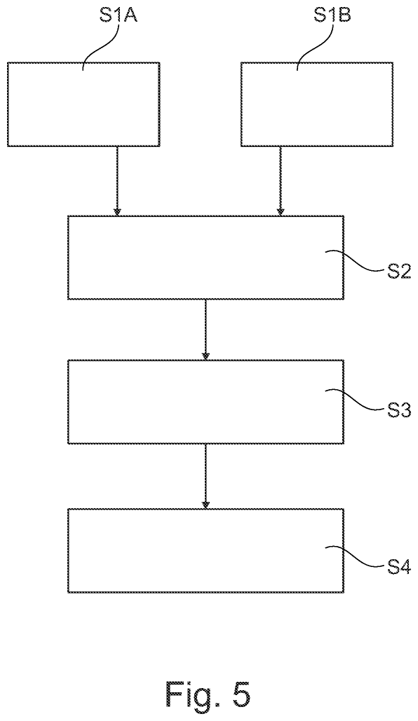

FIG. 5 shows one embodiment of a method of manufacturing the structure 1 for the electric machine 2 and of manufacturing the electric machine 2. The method includes the following acts.

Act S1A includes selecting a material for making the stator 10 based on the coefficient of thermal expansion of the housing 12.

Alternatively or additionally, act S1B is performed, in which a material for making the housing 12 is selected based on the coefficient of thermal expansion of the stator 10.

Act S2 includes providing (e.g., manufacturing) the stator 10 extending around an axis D and having holders 100 for magnetically active elements 11, the housing 12, and a plurality of cooling segments 13A-13D that each at least partially form at least one cooling channel 130 for a cooling fluid F. Therein, the stator 10 and/or the housing 12 are provided (e.g., manufactured) with the material selected in act S1A and/or act S1B.

Act S3 includes assembling the stator 10, the housing 12, and the cooling segments 13A-13D such that the cooling segments 13A-13D are arranged into a ring R. The ring R of the cooling segments 13A-13D is arranged between the stator 10 and the housing 12. The housing 12 is arranged coaxially with the stator 10. Optionally, the housing 12 is arranged such that a form-fitting element 131A, 131B of at least one of the cooling segments 13A-13C cooperates with a form-fitting element 101A, 101B of the stator 10 and a torque T is transmissible about the axis D between the stator 10 and the ring R of the cooling segments 13A-13D. Optionally, the housing 12 is arranged such that a form-fitting element 132A, 132B of at least one of the cooling segments 13A, 13C cooperates with a form-fitting element 120A, 120B of the housing 12 and a torque T is transmissible about the axis D between the ring R of the cooling segments 13A-13D and the housing 12. The structure 1 is then ready for use.

Act S4 includes making the electric machine 2 by rotatably mounting the rotor 20 on the structure 1.

The solution described makes it possible to improve both the resistance (e.g., to plastic deformation or fracture) and the performance of an electric machine at low ambient temperatures.

The structure 1 includes the stator 10, the housing 12, and a cooling system for cooling the stator 10. The cooling system is configured to remove heat from the stator 10 at a predefined reference temperature (e.g., 50° C. or, alternatively, −50° ° C., −20° C., 0° C., 20° C., or 70° C.) with a heat-removal rate that is greater than or equal to 5 kW.

The heat-removal rate may be in the range of 5 kW to 12 kW. For example, the heat-removal rate may be equal to 10 kW.

The cooling system includes the cooling segments 13A-13D arranged between the housing and the stator. The cooling system may include 48 cooling segments. The cooling segments include the cooling channels 130 for the cooling fluid.

Each of the cooling channels 130 may have a surface area of 4000 mm², 5000 mm², 6000 mm², 7000 mm², 8000 mm², or 9000 mm² (e.g., of 9024 mm²; optionally, within a range of +/−10% of one of these values). Each of the cooling channels 130 may have a surface area of any of these values multiplied with 8 or 10.

The cooling channels 130 of the cooling system may have a total surface area of at least 1 m², at least 2 m², or at least 3 m² (e.g., optionally, within a range of +/−10% of one of these values).

Each of the cooling channels 130 may have a cross section of 50 mm² or more, or of 70 mm² or more (e.g., of 74 mm²), and/or each of the cooling channels 130 may have a cross section of less than any of these values multiplied by 8 or 10.

The cooling channels 130 of the cooling system may in sum have a total cross section of at least 10,000 mm², at least 20,000 mm² or of 28,416 mm².

The cooling fluid may be air (e.g., environmental air).

The cooling system may be adapted to supply the cooling fluid to the cooling channels 130 with a mass-flow rate in a range of between 0.3 kg/s and 1.5 kg/s (e.g., with a mass-flow rate of 0.7 kg/s).

The cooling channels 130 may extend in parallel to one another and may be arranged at different locations around the stator 10.

Each of the cooling segments 13A-13D may include one or more cooling channels 130 (e.g., 2 or more, 3 or more, 4 or more, 5 or more, 6 or more, or 7 or more cooling channels 130).

The cooling system may be configured to transmit torque between the stator 10 and the housing 12.

The housing 12 may be coaxially arranged with the stator 10.

The stator 10 may be arranged within the housing 12.

The stator 10 may include electric coils, and the rotor 20 with permanent magnets may be mounted rotatable with respect to the stator 10.

An electric machine 2 may include the structure 1 described herein.

An aircraft engine may include the structure 1 described herein, and a rotor unit 32 with rotor blades 321.

The ratio of the heat-removal rate divided by the maximum electric power may be greater than or equal to 0.015 (e.g., 1.5%), greater than or equal to 0.031 (e.g., 3.1%), or greater than or equal to 0.037 (e.g., 3.7%).

The maximum electric power may be more than 100 KW, more than 200 kW, or more than 300 kW. For example, the maximum electric power is 320 kW.

The elements and features recited in the appended claims may be combined in different ways to produce new claims that likewise fall within the scope of the present invention. Thus, whereas the dependent claims appended below depend from only a single independent or dependent claim, it is to be understood that these dependent claims may, alternatively, be made to depend in the alternative from any preceding or following claim, whether independent or dependent. Such new combinations are to be understood as forming a part of the present specification.

While the present invention has been described above by reference to various embodiments, it should be understood that many changes and modifications can be made to the described embodiments. It is therefore intended that the foregoing description be regarded as illustrative rather than limiting, and that it be understood that all equivalents and/or combinations of embodiments are intended to be included in this description.

1. A structure for an electric machine, the structure comprising:
a stator;
a housing; and
a cooling system for cooling the stator,
wherein the cooling system is configured to remove heat from the stator at a predefined reference temperature with a heat-removal rate that is greater than or equal to 5 kW.

2. The structure of claim 1, wherein the heat-removal rate is equal to 10 kW.

3. The structure of claim 1, wherein the heat-removal rate is smaller than or equal to 12 kW.

4. The structure of claim 1, wherein the predefined reference temperature is 50° C.

5. The structure of claim 1, wherein the cooling system comprises one or more cooling segments arranged between the housing and the stator.

6. The structure of claim 5, wherein the cooling system comprises more than 40 cooling segments.

7. The structure of claim 1, wherein the cooling system comprises cooling channels for a cooling fluid.

8. The structure of claim 7, wherein each of the cooling channels has a surface area of 9000 mm²+/−10%.

9. The structure of claim 7, wherein the cooling channels of the cooling system have a total surface area of at least 3 m².

10. The structure of claim 7, wherein the cooling fluid is air.

11. The structure of claim 7, wherein the cooling system is configured to supply the cooling fluid to the cooling channels with a mass-flow rate in a range of 0.3 kg/s to 1.5 kg/s.

12. The structure of claim 7, wherein the cooling channels extend in parallel to one another and are arranged at different locations around the stator.

13. The structure of claim 5, wherein each of the one or more cooling segments comprises more than five cooling channels.

14. The structure of claim 1, wherein the cooling system is configured to transmit torque between the stator and the housing.

15. The structure of claim 1, wherein the housing is coaxially arranged with the stator.

16. The structure of claim 1, wherein the stator is arranged within the housing.

17. The structure of claim 1, wherein the stator comprises electric coils, and
wherein a rotor with permanent magnets is mounted rotatable with respect to the stator.

18. The structure of claim 1, wherein the structure is in an electric machine.

19. The structure of claim 1, wherein the structure is in an aircraft engine having a rotor unit with rotor blades.

20. A structure for an electric machine, the structure comprising:
a stator;
a housing; and
a cooling system for cooling the stator,
wherein the stator is operable with a maximum electric power, and the cooling system is configured to remove heat from the stator at a predefined reference temperature with a heat-removal rate, and
wherein a ratio of the heat-removal rate divided by the maximum electric power is greater than or equal to 0.015.
